(19) United States
(12) Patent Application Publication
(10) Pub. No.: US 2023/0132472 A1
(43) Pub. Date: May 4, 2023

(54) SYSTEM AND METHOD FOR EFFICIENT HEAT STORAGE AND RETENTION

(71) Applicant: INDIAN OIL CORPORATION LIMITED, Mumbai (IN)

(72) Inventors: Vibhav DIKSHIT, Faridabad (IN); Vinay TIWARI, Faridabad (IN); Umish SRIVASTAVA, Faridabad (IN); Deepak SAXENA, Faridabad (IN); Sankara Sri Venkata RAMAKUMAR, Faridabad (IN)

(73) Assignee: INDIAN OIL CORPORATION LIMITED, Mumbai (IN)

(21) Appl. No.: 17/969,188

(22) Filed: Oct. 19, 2022

(30) Foreign Application Priority Data
Oct. 29, 2021 (IN) 202121049725

(51) Int. Cl. F28D 20/00

(52) U.S. Cl. CPC F28D 20/0056; F28D 2020/0008

(57) ABSTRACT

The present invention relates to a highly efficient system and method for heat storage for modular indoor cooking and other engineering applications comprising of set of carefully selected insulation materials and their arrangement so as to maximize the storage of heat for the desired time duration.

### FIELD OF THE INVENTION

The present invention covers highly efficient system and method for heat storage for modular indoor cooking and other engineering applications comprising of set of carefully selected insulation materials and their arrangement so as to maximize the storage of heat for the desired time duration.

### BACKGROUND OF THE INVENTION

Thermal energy is abundantly available from various sources in multiple forms, such as renewable solar energy or from other such sources. Several techniques of capturing and using thermal energy are available at different scales.

Various prior art devices have been used to capturing and storing thermal energy for utilization of the same for different applications.

The different configurations are used in the prior art are discussed in RU2618633C2 [P1] US20200132393A1 [P2], AU2005222444B2 [P3]

P1 discloses a thermal energy storage device comprising of metal medium for energy storage. The concentrated solar power heater is embedded in the metal medium to provide heat. The device includes a floor, outer wall and central pillar made up of concrete which is surrounded with a helical coiled heat exchanger. The design has double insulation of the metallic medium, consisting of metal mirror for reflecting infrared rays, high-density fire-resistant heat insulating material, porous fire-resistant heat insulating material and flame retardant thermal insulation material.

The thermal cell described in P2 includes at least one crucible for containment of PCM such as aluminum silicon alloys, aluminum, magnesium chloride, sodium chloride and potassium chloride etc. It also includes a casing and a thermal interface which can be graphite/CNT/graphene. The thermal interface has at least one heating element and heat conduit embedded inside it. The system in the art utilizes four layers of insulation which may consist of thermal insulation boards, thermal insulation blanks, fiberglass, mineral wool, polymer, carbolane blankets and foams etc.

P3 discloses a graphite based thermal energy storage for elevated temperature and method of utilizing the heat from the same. The system contains a resistor disposed in inner region of graphite which be powered by renewable energy source or off-peak electricity. The method contains the plurality of graphite bodies with plurality of heat exchanger for utilization of stored heat to generate steam which drives a turbine to generate power. The graphite block in this system can be surrounded with the internally evacuated jacket. The radiative losses are minimized in this art by high polishing of inner surface of jacket and outer surface of the block. The space between jacket and body is filled with the help of plurality of insulating spacers made up of ceramic or refractory material.

Major challenges present in prior art is to accommodate the any kind of thermal storage material and efficiently storing the thermal energy for the long duration with minimum heat loss which can be used for indoor and stationary cooking and for other engineering application. The prior arts do not teach in details the method (s) by which different quality of heat can be effectively insulated and retained based on intended application (s).

To overcome some of the problems and shortcoming of the prior art a need exist for new and improved system and method for efficient heat storage and retention for modular applications such as cooking, water heating, power generation etc.

Objectives of the Present Invention:

To overcome some of the problems and shortcoming of the prior art a need exists for new and efficient system for heat storage and retention.

It is an objective of this invention to provide a provide a reliable, system for efficient heat storage and retention for modular cooking and other engineering applications requiring heat.

It is further objective of the invention to provide a thermal storage insulated by a single layer or a combination of insulation materials.

It is yet another objective of the invention to provide a different configurations of insulation arrangement as per different grade of insulations based on their thermal and physical properties.

It is yet another objective of the invention to provide a thermal storage applicable for different quality of heat retention.

It is yet another objective of the invention to provide a thermal storage with insulated chambers for different kind and sizes of thermal storage material.

It is the further objective of the invention is to provide a modular system/method for accommodating different type and sizes of heat storage materials as per requirement.

It is the further objective of the present invention is to provide a thermal storage with insulated chambers for different kind and sizes of thermal storage material.

It is the further objective of the present invention is to provide a heat resistant and thermal insulation paint coated on thermal storage material's outer side and reflector/foil/paper inserted between each layer of insulation as well as provided on inner surface of enclosure body to reduce the further radiation heat losses.

It is an objective of this invention to provide a provide a reliable, method for efficient heat storage and retention for modular cooking and other engineering applications requiring heat using the system as in the present invention.

Further the object of this invention is to provide a highly efficient system and method for heat storage for modular indoor cooking and other engineering applications comprising of set of carefully selected insulation materials and their arrangement so as to maximize the storage of heat for the desired time duration.

### SUMMARY OF THE PRESENT INVENTION

This summary is provided to introduce a selection of concepts, in a simplified format, that are further described in the detailed description of the invention. This summary is neither intended to identify key or essential inventive concepts of the invention and nor is it intended to determine the scope of the invention.

To overcome some of the problems and shortcoming of the prior art a need exists for system and method for heat storage for modular indoor cooking and other engineering applications comprising of set of carefully selected insulation materials and their arrangement so as to maximize the storage of heat for the desired time duration.

In one of the embodiments, the invention discloses a system (10) for heat storage comprising;

a plurality of thermal insulation layers (Grade 1, Grade 2, Grade 3) adapted to retain heat;

a glass or aluminum reflector or a foil or a paper (4) inserted between each layer of insulation adapted to reduce the further radiation losses;

an insulated lid to cover the heat storage; and

a heat resistant and thermal insulation paint (5) coated on outer side of a heat storage material adapted to minimize the radiative heat loss.

In yet one of the embodiments, the present invention provides a method for heat storage using a system for heat storage, the method comprising;

reducing flow of heat through heat storage material by providing a plurality of insulation layers around the heat storage material;

arranging insulation layers based on requirement of quality of heat storage;

inserting material such as glass or aluminum reflector or a foil or a paper glass or between each layer of insulation

painting heat resistant and thermal insulation paint coated on outer side of a heat storage material adapted to minimize the radiative heat loss.

In yet one of the embodiments, the present invention provides a reliable, system and method for efficient heat storage and retention by consideration of minimizing the conductive and radiation heat losses.

In yet one of the embodiments, the present invention provides thermal storage applicable for different quality of heat retention.

In yet one of the embodiments, the present invention provides a system can be used in all kinds of stationary as well as portable systems depending upon the quantity of heat to be stored in line with its intended application.

In yet one of the embodiments, the present invention provides an optimized arrangement of layers of same or dissimilar insulations for minimal heat loss (least radiative & conductive heat losses).

In yet one of the embodiments, the present invention provides a modular system for accommodating different kind and sizes of thermal storage materials as per requirement with long duration different quality of heat retention of thermal battery.

In yet one of the embodiments, the present invention provides a reliable, system and method for efficient heat storage and retention Safe in operation as well as maintenance.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE ACCOMPANYING DRAWINGS

These and other features, aspect, and advantages of the present invention will become better understood when the following detailed description is read with reference to the accompanying drawings in which like characters represent like parts throughout the drawings, wherein the device and process and digester configurations described in the present invention are explained in more detail with reference to the following drawings:

FIG. 1 illustrates a system for efficient heat storage and retention.

FIG. 2 illustrates Heat flow through conduction for each insulation material.

FIG. 3 illustrates critical thickness of insulation for minimum heat loss.

FIG. 4 illustrates different embodiments for different quality of heat retention.

### DETAILED DESCRIPTION OF THE INVENTION

For the purpose of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skills in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

Embodiments of the present invention will be described below in detail with reference to the accompanying drawings.

While the invention is susceptible to various modifications and/or alternative adaptations, specific embodiment thereof has been shown by way of examples and will be described in detail below. However, it should be understood, that it is not intended to limit the invention to the particular structural arrangement disclosed, but on the contrary, the invention is to cover all modifications, structural adaptations and alternative falling within the spirit and the scope of the invention as defined herein.

This invention relates to a highly efficient system and method for heat storage for modular indoor cooking and other engineering applications comprising of set of carefully selected insulation materials and their arrangement so as to maximize the storage of heat for the desired time duration.

The system can be used in stationary as well as portable system depending upon the quantity of heat to be stored in line with its intended application. System/method is modular for accommodating different type and sizes of heat storage materials as per requirement.

Heat may be transferred in three mechanisms: conduction, convection and radiation. Heat transfers through insulation material occur by means of conduction, while heat loss to or heat gain from atmosphere occurs by means of convection and radiation.

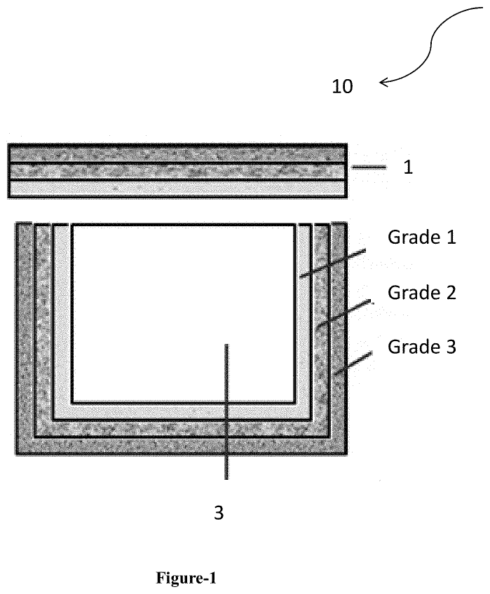

Inventions provide a reliable, system and method for efficient heat storage and retention by consideration of minimizing the conductive and radiation heat losses. System is designed based on the optimization of flow of heat through heated object to surrounding by combination of different grade of insulations as shown in FIG. 1.

According to the main embodiment the system (10) may be adapted to include a plurality of thermal insulation layers (Grade 1, Grade 2, Grade 3) adapted to retain heat in the system. The heat storage system may also be adapted to include a heat resistant and thermal insulation paint (5) coated on the outer side of the heat/thermal storage material (3). Other configurations like glass or aluminum reflector/foil/paper (4) can be inserted between each layer of insulation as well as can be provided on inner surface of enclosure body to reduce the further radiation losses.

Thermal storage system (10) is insulated by a single layer or a combination of insulation materials which may be fiberglass, super wool, ceramic fiber, polycrystalline fiber, vacuum insulation and any other thermal insulation.

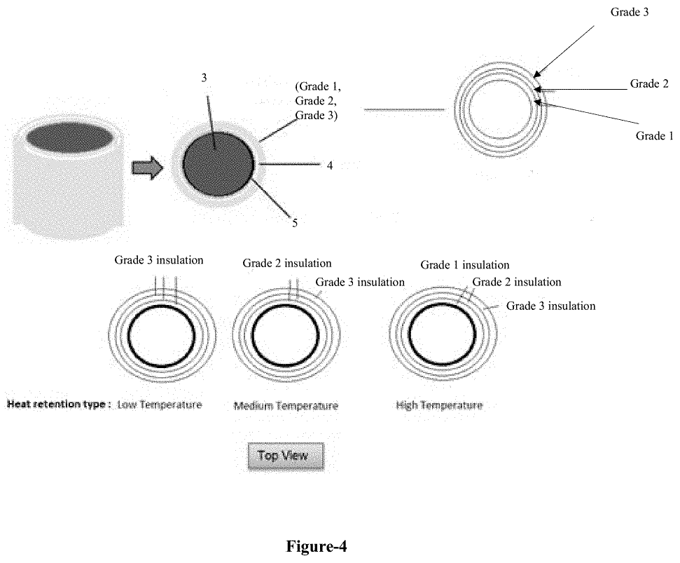

Insulation arrangement is done based on quality of heat retention (Low temperature: up to 150° C./Medium temperature: 150° C.-350° C./High Temperature: 350° C.-1000° C.) required for particular application. Different configurations of insulation arrangement are enclosed as per different grade of insulations based on their thermal and physical properties (density, operating temperature limits, thermal conductance, thermal conductivity, emissivity and thermal transmittance etc.) are shown in FIG. 4. Properties of different grades of insulation is in order of Grade 1>Grade 2>Grade 3. These different embodiments are applicable for different quality of heat retention.

Thermal insulation provides a region for insulation in which thermal conduction is reduced or thermal radiation is reflected rather than absorbed by the lower temperature body. Thermal insulation materials have a low thermal conductivity, which have a high proportion of small voids containing air or gases. These voids are not big enough to transmit heat by convection or radiation, and therefore reduce the flow of heat.

The heat flow is proportional to a temperature difference according to this equation:

Q=k×A×ΔT/Δx

where Q is the heat flow, k is the thermal conductivity of the insulation material, A is the surface area normal to the flow of heat, Δx is the distance that the heat flows, and ΔT is the temperature difference driving the heat flow.

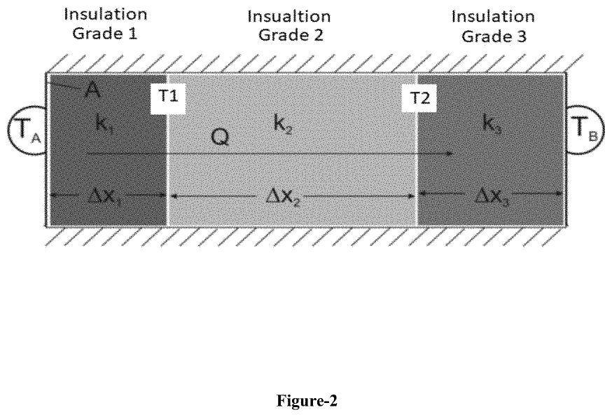

The heat flow through a wall composed of three different grade insulation materials as shown in FIG. 2, where the surface temperatures at each outside surface, TA, and TB, and T1 is the temperature of contact surface in between insulation materials grade 1 and grade 2 and T2 is the temperature of contact surface in between insulation material grade 2 and grade 3. Thermal conductivity of insulation materials Grade 1, Grade 2 and Grade 3 are k1, k2 and k3 respectively.

Heat flow thru conduction for each insulation material:

Qgrade1=k1×A×(T1−TA)/Δx1

Qgrade2=k2×A×(T2−T1)/ΔX2

Qgrade3=k3×A×(TB−T2)/ΔX3

Qconductive=(Qgrade1+Qgrade2+Qgrade3)

Other than insulation material arrangement, high temperature paint and reflector arrangement are provided on heat emitting surface of heating object to minimize the radiative losses. The radiative Heat flow would be:

Qradiative=ε×σ×A×(Ts4−Tsurr4)

Where c is the emissivity of the surface, σ is the Stefan-Boltzmann constant, Ts is the surface temperature of the emitting surface, and Tsurr is the temperature of the surroundings.

Therefore, the total heat flow from heating object would be:

Qtotal=Qconductive+Qradiative

Qtotal is minimized by optimal arrangement of different grades of Insulation material based on quality of heat retention (Low temperature: up to 150° C./Medium temperature: 150° C.-350° C./High Temperature: 350° C.-1000° C.) required for particular application.

Different configurations of insulation arrangement are enclosed as per different grade of insulations based on their thermal and physical properties (density, operating temperature limits, thermal conductance, thermal conductivity, emissivity and thermal transmittance etc.) are shown in FIG. 4. Properties of different grades of insulation is in order of Grade 1>Grade 2>Grade 3. High temperature heat resistant paint or reflectors are provided on outer surface of heating object to reduce the radiative heat losses.

In case of low heat retention requirement,

combination of different layers of grade 3 insulations is used.

For medium heat retention

combination of grade 2 in the innermost layer, the intermediate layer and the outer layer is used.

in some cases, the medium quality of heat retention grade 2 insulation is placed in innermost layer followed by both an intermediate layer of grade 2 and outer layer of grade 3 or intermediate layer of grade 3 insulations are placed going outward layers.

For high quality of heat retention

grade 1 insulation is placed in layers

in some cases, grade 1 insulation is placed in inner layer followed by grade 2-grade 2 or grade 2-grade 3 or grade 3-grade 3 insulations used successively moving outwards.

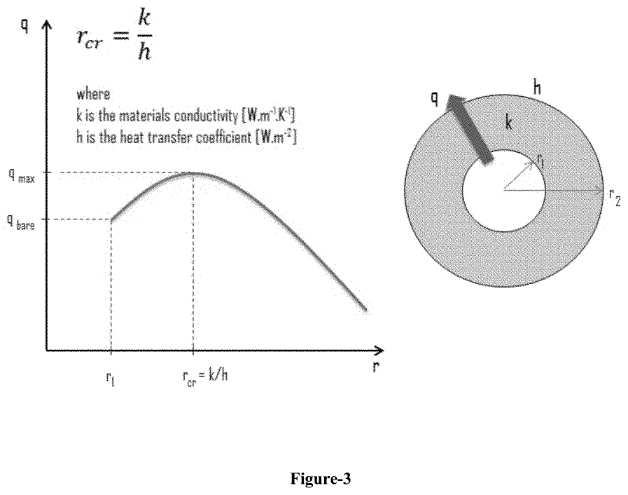

The thickness upto which heat flow increases and after which heat flow decreases is termed as critical thickness. Critical thickness of insulation depends on the thermal conductivity of the insulation k and the external convection heat transfer coefficient h as shown in FIG. 3.

As can be seen, if r1<rcr, as it is in this case, the total heat resistance decreases, and the heat transfer rate therefore increases with the addition of insulation. This trend continues until the outer radius of the insulation corresponds to the critical radius, where the heat transfer rate reaches its maximum. On the other hand, any further addition of material (beyond rcr) would increase the total resistance and therefore decrease the heat loss.

The heat flow through a wall composed of three different grade insulation materials as shown in FIG. 2, where thermal conductivity of insulation materials Grade 1, Grade 2 and Grade 3 are k1, k2 and k3 respectively.

Therefore, critical thickness for complete insulated system is calculated as follows to achieve minimum heat loss:

rcr=(k1+k2+k3)/h

System is well insulated by optimized quantity of insulation material and results average standby heat loss <7% per hour which provide long duration of heat retention.

Thermal storage is insulated by a single layer or a combination of insulation materials which may be Fiberglass, Glass Wool, Ceramic fiber, Polycrystalline Fiber, vacuum insulation and any other thermal insulation.

Heat Resistant & Thermal Insulation Paint may also be coated on thermal storage material's outer side to minimize the radiative heat loss.

Other configurations like glass or aluminum reflector/foil/paper can be inserted between each layer of insulation as well as can be provided on inner surface of enclosure body to reduce the further radiation losses.

A tentative list of different grades of insulation materials which are used in invention but not limited to is given below:

| | | | | Thermal | |
|---|---|---|---|---|---|
| | | | | conductivity | |
| sl. | | Grade | Temperature | range, k | Density |
| No. | Insulation type | Type | range | (Watt/meter ° K) | (kg/m3) |
| 1. | GLASS FIBER | Grade 3 | 0-150 Degree | 0.025-0.035 | 24-50 |
| | POLYSTYRENE | | C. | | |
| | GLASS CELLULAR | | | | |
| | ELASTOMERIC FOAM | | | | |
| | POLYURETHANE | | | | |
| | POLYISOCYANURATE | | | | |
| 2. | CALCIUM SILICATE | Grade 2 | 150° C.-350° C. | 0.027-0.076 | 15-200 |
| | GLASS CELLULAR | | | | |
| | GLASS FIBER | | | | |
| | MINERAL FIBER | | | | |
| | PERLITE | | | | |
| | ELASTOMERIC FOAM | | | | |
| | POLYSTYRENE | | | | |
| | POLYURETHANE | | | | |
| | POLYETHYLENE | | | | |
| | POLYISOCYANURATE | | | | |
| 3. | CALCIUM SILICATE | Grade 1 | 350° C.-1000° C. | .083-0.15 | 64-190 |
| | CLASS CELLULAR | | | | |
| | HIGH TEMP | | | | |
| | GLASS FIBER | | | | |
| | MINERAL FIBER | | | | |
| | PERLITE | | | | |
| | CERAMIC FIBER | | | | |
| | HIGH TEMPERATURE | | | | |
| | MINIREAL WOOL | | | | |

Technical Advantages of the Invention:

The present invention has the following advantage over the prior arts:

Optimized arrangement of layers of same or dissimilar insulations for minimal heat loss (least radiative & conductive heat losses)

Modular for accommodating different kind and sizes of thermal storage materials as per requirement

Long duration different quality of heat retention of thermal battery

Utilized as stationary and portable application

Highly efficient

Safe in operation as well as maintenance

While specific language has been used to describe the present subject matter, any limitations arising on account thereto, are not intended. As would be apparent to a person in the art, various working modifications may be made to the method in order to implement the inventive concept as taught herein.

We claim:

1. A system for heat storage comprising;
a plurality of thermal insulation layers adapted to retain heat;
a glass or aluminum reflector or a foil or a paper inserted between each layer of insulation adapted to reduce further radiation losses;
an insulated lid to cover the heat storage; and
a heat resistant and thermal insulation paint coated on outer side of a heat storage material adapted to minimize the radiative heat loss.

2. The system as claimed in claim 1, wherein the thermal insulation layers can be of the same or different material.

3. The system as claimed in claim 2, wherein the thermal insulation layer material is fiberglass, super wool, ceramic fiber, polycrystalline fiber, vacuum insulation, and any other thermal insulation.

4. The system as claimed in claim 1, wherein the thermal insulation can be a single layer.

5. The system as claimed in claim 1, wherein the system is modular for different configurations of insulation arrangement.

6. The system as claimed in claim 5, wherein the insulation layers are graded based on their thermal and physical properties.

7. The system as claimed in claim 6 wherein insulation layer for maximum heat storage is grade 1 insulation material, for medium heat storage insulation layer is grade 2 insulation material and for low heat storage insulation layer is grade 3 insulation material.

8. The system as claimed in claim 1, wherein the system is rechargeable and portable.

9. The system as claimed in claim 1, further comprises insulated chambers for different kind and sizes of thermal storage material.

10. A method for heat storage using a system for heat storage, the method comprising;
reducing flow of heat through heat storage material by providing a plurality of insulation layers around the heat storage material;
arranging insulation layers based on requirement of quality of heat storage;
inserting material such as glass or aluminum reflector or a foil or a paper glass or between each layer of insulation;
painting heat resistant and thermal insulation paint coated on outer side of a heat storage material adapted to minimize the radiative heat loss.

11. A method as claimed in claim 10 wherein the arranging of layers of insulation for maximum heat storage by grade 1 insulation material, for medium heat storage by grade 2 insulation material and for low heat storage by grade 3 insulation material.
